(19) United States
(12) Patent Application Publication
(10) Pub. No.: US 2022/0038601 A1
(43) Pub. Date: Feb. 3, 2022

(54) INFORMATION PROCESSING APPARATUS, INFORMATION PROCESSING METHOD, AND NONTRANSITORY RECORDING MEDIUM

(71) Applicant: RICOH COMPANY, LTD., TOKYO (JP)

(72) Inventor: Naoto HAMADA, Kanagawa (JP)

(73) Assignee: RICOH COMPANY, LTD., TOKYO (JP)

(21) Appl. No.: 17/352,936

(22) Filed: Jun. 21, 2021

(30) Foreign Application Priority Data
Jul. 31, 2020 (JP) 2020-130850

(51) Int. Cl. H04N 1/32; H04N 1/00

(52) U.S. Cl. CPC H04N 1/32432; H04N 1/00212; H04N 1/32496; H04N 1/32128

(57) ABSTRACT

An information processing apparatus, an information processing method, and a non-transitory recording medium. The information processing apparatus receives facsimile data, identify a distribution destination folder to which the facsimile data is to be accumulated, from among one or more folders in one or more memories, and when the distribution destination folder is not identified, control a printer to print out an image based on the facsimile data.

### CROSS-REFERENCE TO RELATED APPLICATIONS

This patent application is based on and claims priority pursuant to 35 U.S.C. § 119(a) to Japanese Patent Application No. 2020-130850, filed on Jul. 31, 2020, in the Japan Patent Office, the entire disclosure of which is hereby incorporated by reference herein.

### BACKGROUND

### Technical Field

The present disclosure relates to an information processing apparatus, an information processing method, and a non-transitory recording medium.

### Related Art

A multifunction peripheral (MFP), for example, is often equipped with a reception accumulation function for accumulating documents received by facsimile transmission in a folder in the MFP for paperless operation. In addition, the reception accumulation function may be provided with a folder distribution function for each specific transmission source, which is a function of dividing folders to accumulate data received by a facsimile function, such as a facsimile reception document for each transmission source of facsimile data.

### SUMMARY

Embodiments of the present disclosure describe an information processing apparatus, an information processing method, and a non-transitory recording medium. The information processing apparatus receives facsimile data, identify a distribution destination folder to which the facsimile data is to be accumulated, from among one or more folders in one or more memories, and when the distribution destination folder is not identified, control a printer to print out an image based on the facsimile data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of an overall configuration of a system in which an MFP receives facsimile data according to embodiments of the present disclosure;

FIG. 2 is a block diagram illustrating an example of a hardware configuration of the MFP, according to embodiments of the present disclosure;

FIG. 3 is a block diagram illustrating an example of a functional configuration of the MFP, according to embodiments of the present disclosure;

FIG. 4 is a diagram illustrating an example of a folder management table;

FIG. 5 is a diagram illustrating an example of a distribution destination condition management table;

FIG. 6 is a diagram illustrating a display process of a list of folders including destination names;

FIG. 7 is a diagram illustrating a display process of a list of password protected folders;

FIG. 8 is a diagram illustrating an example of a folder list screen;

FIG. 9 is a diagram illustrating an example of a folder creation screen;

FIG. 10 is a sequence diagram illustrating an example of a distribution destination folder setting process of the MFP according to embodiments of the present disclosure;

FIG. 11 is a diagram illustrating an example of a distribution destination folder registration screen;

FIG. 12 is a flowchart illustrating an example of a folder extraction process for extracting a folder satisfying a predetermined condition in the distribution destination folder setting process;

FIG. 13 is a diagram illustrating an example of an extracted folder list screen;

FIG. 14 is a flowchart illustrating another example of the folder extraction process for extracting the folder satisfying the predetermined condition in the distribution destination folder setting process;

FIG. 15 is a diagram illustrating another example of the extracted folder list screen;

FIG. 16 is a diagram illustrating an example of a priority display setting table; and

FIG. 17 is a sequence diagram illustrating an example of a facsimile reception process of the MFP according to embodiments of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming apparatus, an information processing method, and a non-transitory recording medium according to embodiments of the present disclosure is described below in detail with reference to the accompanying drawings. The present disclosure, however, is not limited to the following embodiments, and the constituent elements of the following embodiments include elements that can be easily conceived by those skilled in the art, those being substantially the same ones, and those being within equivalent ranges. Furthermore, various omissions, substitutions, changes, and combinations of the constituent elements can be made without departing from the gist of the following embodiments.

In addition, computer software refers to programs related to computer operations and other information used for processing by computers that are equivalent to programs (hereinafter, computer software is referred to as software). An application program, which may be simply referred to as “application”, is a general term for any software used to perform certain processing. An operating system (hereinafter simply referred to as an “OS”) is software for controlling a computer, such that software, such as application, is able to use computer resource. The OS controls basic operation of the computer such as input or output of data, management of hardware such as a memory or a hard disk, or processing to be executed. The application software operates by utilizing the functions provided by the OS. The program is a set of instructions for causing the computer to perform processing to have a certain result. While data to be used in processing according to the program is not a program itself, such data may define processing to be performed by the program such that the data to be used in processing may be interpreted as equivalent to the program. For example, a data structure, which is a logical structure of data described by an interrelation between data elements, may be interpreted as equivalent to the program.

Note that an MFP, which is an example of an image forming apparatus, a normal facsimile receiver, a personal computer (PC), and the like are assumed as an information processing apparatus that receives facsimile data from a transmission source device in the present embodiment, but the MFP is used as an example in the description. The MFP is an example of an image forming apparatus including at least two functions of a copy function, a printer function, a scanner function, and a facsimile function.

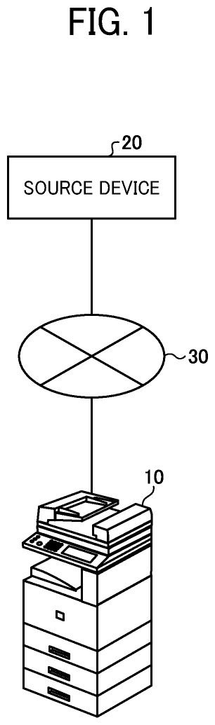

FIG. 1 is a diagram illustrating an example of an overall configuration of a system in which an MFP receives facsimile data according to the present embodiment. Referring to FIG. 1, an overall configuration of a system in which an MFP 10 receives facsimile data according to the present embodiment is described.

The MFP 10 illustrated in FIG. 1 is an image forming apparatus that receives facsimile data from a source device 20 through a public network 30. The source device 20 is a facsimile transmission apparatus that transmits facsimile data to the MFP 10 through the public network 30, and is, for example, a device owned by a transaction partner of a company that owns the MFP 10. The source device 20 may be an MFP, a normal facsimile receiver, a PC, or the like. Further, the source device 20 is an example of the transmission source of the facsimile data received by the MFP 10, and there are other devices that transmit the facsimile data to the MFP 10.

The public network 30 is, for example, an analog line or a digital line such as an integrated services digital network (ISDN).

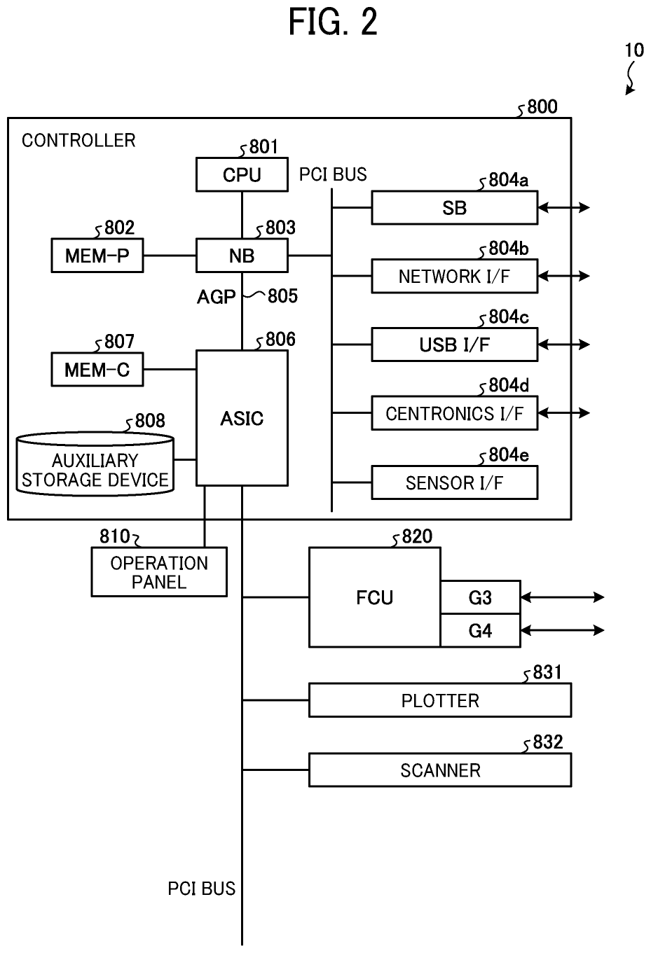

FIG. 2 is a block diagram illustrating an example of a hardware configuration of the MFP according to the present embodiment. The hardware configuration of the MFP 10 according to the present embodiment is described with reference to FIG. 2.

As illustrated in FIG. 2, the MFP 10 includes a controller 800, an operation panel 810, a facsimile control unit (FCU) 820, a plotter 831 (printer), and a scanner 832 connected by a Peripheral Component Interface (PCI) bus.

The controller 800 is a device for controlling the entire MFP 10, rendering, communication, and input from the operation panel 810.

The operation panel 810 is, for example, a touch panel or the like that receives an input to the controller 800 (input function), displays a state of the MFP 10 or the like (display function), and is directly connected to an application specific integrated circuit (ASIC) 806 described below.

The FCU 820 implements a facsimile function, and is connected to the ASIC 806 by, for example, the PCI bus.

The plotter 831 implements a printing function and is connected to the ASIC 806 by, for example, the PCI bus. The scanner 832 implements a scanner function and is connected to the ASIC 806 by, for example, the PCI bus.

The controller 800 includes a central processing unit (CPU) 801, a system memory (MEM-P) 802, a north bridge (NB) 803, a south bridge (SB) 804a, a network interface (I/F) 804b, a universal serial bus (USB) I/F 804c, a Centronics I/F 804d, a sensor I/F 804e, the ASIC 806, a local memory (MEM-C) 807, and an auxiliary storage device 808.

The CPU 801 performs overall control of the MFP 10 and is connected to a chipset including the system memory 802, the northbridge 803, and the southbridge 804a, and is connected to other devices through the chipset.

The system memory 802 is a memory used as a memory for storing programs and data, a memory for expanding programs and data, a memory for rendering of a printer, and the like, and includes a read only memory (ROM) and a random access memory (RAM). The ROM is a read only memory used as a memory for storing programs and data, and the RANI is a memory for expanding programs and data, and a writable and readable memory used as a rendering memory for a printer and the like.

The NB 803 is a bridge for connecting the CPU 801 to the MEM-P 802, the SB 804a, and the accelerated graphics port (AGP) bus 805 and includes a memory controller that controls reading and writing to the MEM-P 802, a PCI master, and an AGP target.

The SB 804a connects the NB 803 with a PCI device and a peripheral device. The SB 804a is connected to the NB 803 through a PCI bus, and the network I/F 804b, USB I/F 804c, Centronics I/F 804d, sensor I/F 804e, and the like are connected to the PCI bus.

The AGP bus 805 is a bus interface for a graphics accelerator card proposed for speeding up graphics processing. The AGP bus 805 directly accesses the MEM-P 802 with high throughput to accelerate the graphics accelerator card.

The ASIC 806 is an integrated circuit (IC) dedicated to an image processing use, and connects the AGP bus 805, the PCI bus, the auxiliary storage device 808, and the MEM-C 807. The ASIC 806 includes a PCI target, an AGP master, an arbiter (ARB) as a central processor of the ASIC 806, a memory controller for controlling the MEM-C 807, a plurality of direct memory access controllers (DMACs) that rotate image data using hardware logic, etc., and a PCI unit that transfers data between the scanner 832 and the plotter 831 through the PCI bus. The FCU 820, the plotter 831 and the scanner 832 are connected to the ASIC 806 through, for example, the PCI bus.

The MEM-C 807 is a memory used as a copy image buffer and a code buffer.

The auxiliary storage device 808 is a storage device such as a hard disk drive (HDD), solid state drive (SSD), secure digital (SD) card, or flash memory, and stores image data, programs, font data, and the like.

The hardware configuration of the MFP 10 illustrated in FIG. 2 is an example and may not include all the components illustrated in FIG. 2 or may include other components.

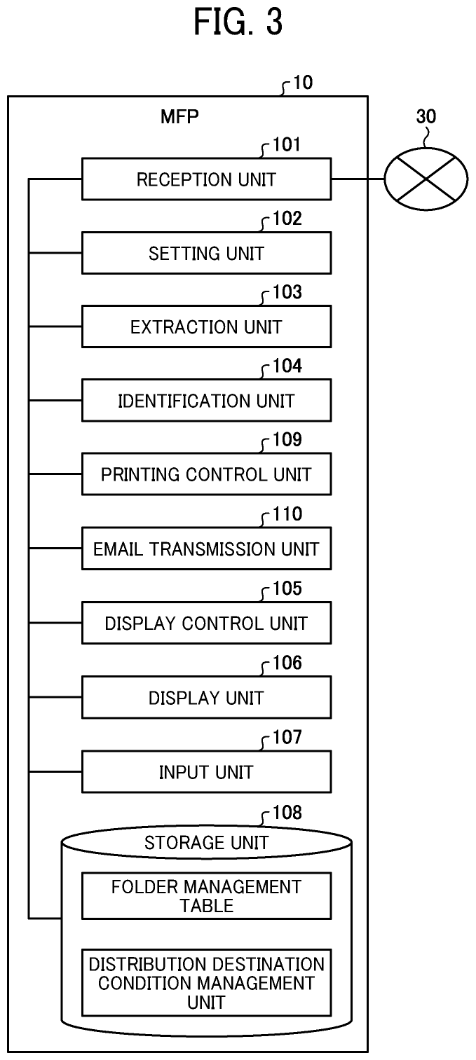

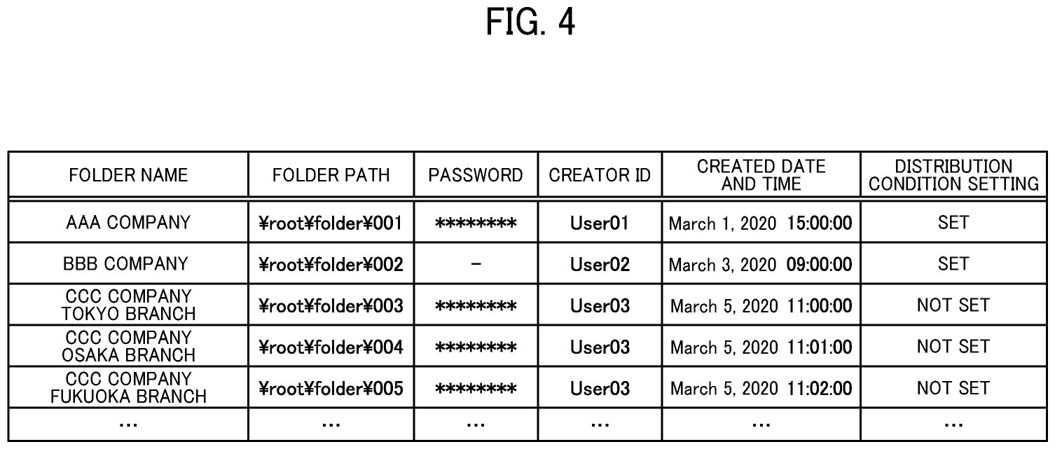

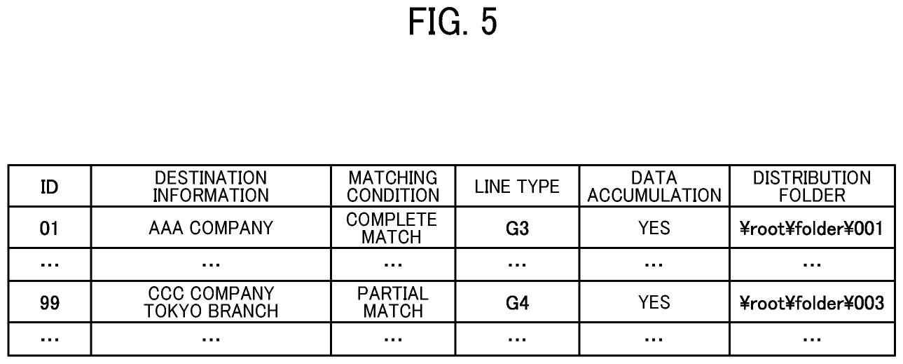

FIG. 3 is a block diagram illustrating an example of a functional configuration of the MFP according to the present embodiment. FIG. 4 is a diagram illustrating an example of a folder management table. FIG. 5 is a diagram illustrating an example of a distribution destination condition management table. The configuration and operation of the functions of the MFP 10 according to the present embodiment is described with reference to FIGS. 3 to 5.

As illustrated in FIG. 3, the MFP 10 includes a reception unit 101, a setting unit 102, an extraction unit 103, an identification unit 104, a display control unit 105, a display unit 106, an input unit 107, a storage unit 108, a printing control unit 109, and an email transmission unit 110.

The reception unit 101 receives facsimile data from an external device (such as the source device 20) through the public network 30. In addition, the reception unit 101 extracts transmission source identification information for identifying a transmission source (for example, a facsimile number of the transmission source or a device name of the transmission source device) from the received facsimile data. The reception unit 101 is implemented by a program executed by the CPU 801 illustrated in FIG. 2 and the FCU 820.

The setting unit 102 manages and controls setting operations performed on a folder list screen 1000, a distribution destination folder registration screen 1200, and the like, which are described below. The setting unit 102 is implemented by, for example, a program executed by the CPU 801 illustrated in FIG. 2.

The extraction unit 103 extracts from a folder list including all folders, a folder that satisfies a condition set on the distribution destination folder registration screen 1200 described below. The extraction unit 103 is implemented by, for example, a program executed by the CPU 801 illustrated in FIG. 2.

The identification unit 104 identifies the distribution destination information (record) corresponding to the source identification information of the facsimile data received by the reception unit 101 from the distribution destination condition management table illustrated in FIG. 5 stored in the storage unit 108. The identification unit 104 acquires a path of the distribution destination folder from the identified distribution destination information. The identification unit 104 is implemented by, for example, a program executed by the CPU 801 illustrated in FIG. 2.

The display control unit 105 controls display operation of the display unit 106. The display control unit 105 is implemented by, for example, a program executed by the CPU 801 illustrated in FIG. 2.

The display unit 106 displays various screens under the control of the display control unit 105. The display unit 106 is implemented by the display function of the operation panel 810 illustrated in FIG. 2.

The input unit 107 receives an operation input from a user. The input unit 107 is implemented by the input function of the operation panel 810 illustrated in FIG. 2.

The storage unit 108 stores various types of information. The storage unit 108 stores, for example, the folder management table illustrated in FIG. 4 and the distribution destination condition management table illustrated in FIG. 5. The storage unit 108 stores (accumulates) the facsimile data received by the reception unit 101 in the set distribution destination folder. The storage unit 108 is implemented by the auxiliary storage device 808 illustrated in FIG. 2.

The folder management table illustrated in FIG. 4 is a table for managing folders created in the storage unit 108. As illustrated in FIG. 4, the folder management table stores a folder name of the folder, a folder path indicating the path of the folder, a password set for the folder, a creator identifier (ID) indicating a creator who created the folder, the creation date and time when the folder was created, and distribution condition setting indicating whether the folder has already been set as the distribution destination folder, in association with each other. For example, in FIG. 4, a folder name “CCC Company Tokyo Branch”, a folder path “¥root¥folder¥003”, a password “* * *”, a creator ID “User03”, a creation date and time “Mar. 5, 2020 11:00:00”, and a distribution condition setting “not set” are associated with each other.

The distribution destination condition management table illustrated in FIG. 5 is a table for determining and registering a distribution destination folder, which is a folder to which received facsimile data is distributed for each transmission source. As illustrated in FIG. 5, the distribution destination condition management table stores an ID that is identification information of each record, source information indicating a transmission source, a matching condition indicating a matching condition to extract a distribution destination folder using the source information, a line type indicating a type of facsimile line, data accumulation indicating necessity of storage of facsimile data, and a distribution destination folder indicating a path of the distribution destination folder determined as a folder to which the facsimile data is to be distributed, in association with each other. For example, in FIG. 5, the ID “01”, the source information “AAA Company”, the matching condition “complete match”, the line type “G3”, the data accumulation “yes”, and the distribution destination folder path “¥root¥folder¥001” are associated with each other.

The printing control unit 109 controls printing operation of the plotter 831. The printing control unit 109 prints out the facsimile data when the identification unit 104 cannot identify the distribution destination folder of the facsimile data received by the reception unit 101. The printing control unit 109 is implemented by, for example, a program executed by the CPU 801 illustrated in FIG. 2.

The email transmission unit 110 transmits an email to a predetermined email address (for example, an email address of an administrator or the like) through the network I/F 804b, indicating that the distribution destination folder is not identified by the identification unit 104 and the facsimile data received by the reception unit 101 is printed by the printing control unit 109. In addition to transmitting the fact that the facsimile data has been received by the reception unit 101 or printed, the email transmission unit 110 may attach the facsimile data to the email. The email transmission unit 110 is implemented by, for example, a program executed by the CPU 801 illustrated in FIG. 2.

The setting unit 102, the extraction unit 103, the identification unit 104, the display control unit 105, the printing control unit 109, and the email transmission unit 110 described above are implemented by executing a program that is software, but are not limited thereto, and at least one of these functional units may be implemented by a dedicated hardware circuit (integrated circuit or the like).

Further, each functional unit of the MFP 10 illustrated in FIG. 3 conceptually represents a function and the configuration is not limited to the diagram illustrated in FIG. 3. For example, a plurality of functional units illustrated as independent functional units in the MFP 10 in FIG. 3 may be configured as one functional unit. On the other hand, in the MFP 10 illustrated in FIG. 3, a function of one functional unit may be divided into a plurality of functional units.

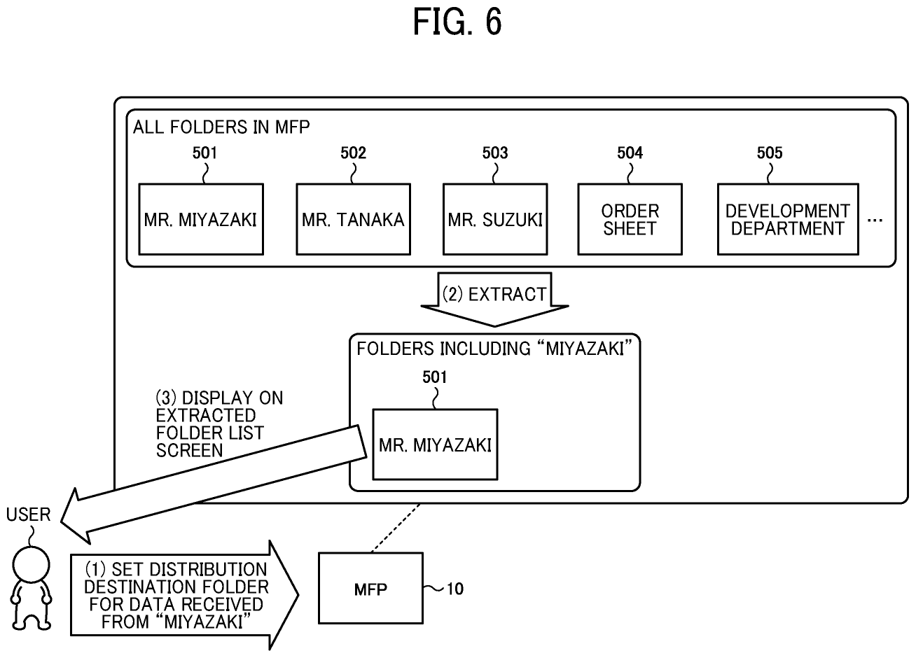

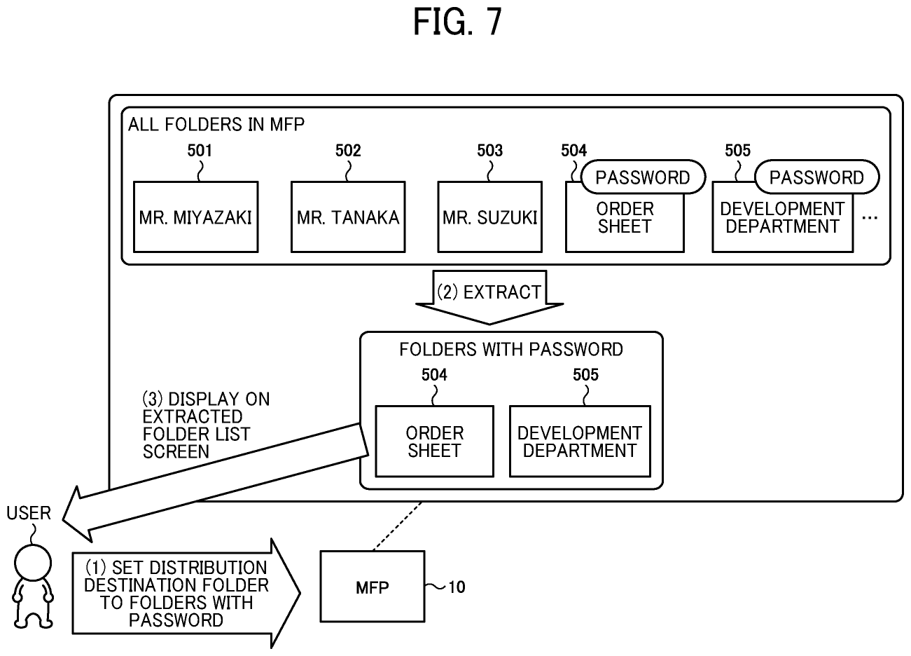

FIG. 6 is a diagram illustrating a display process of a list of folders including source names. FIG. 7 is a diagram illustrating a display process of a list of password protected folders. With reference to FIGS. 6 and 7, an outline of operation of extracting folders satisfying an extraction condition from folders and displaying a list thereof in the MFP 10 according to the present embodiment is described.

FIG. 6 illustrates the operation of extracting folders based on an extraction condition that the source name is included in a folder name and displaying a list of folders that are candidates for a folder to which facsimile data is to be distributed. In addition, as illustrated in FIG. 6, it is assumed that five folders of folders 501 to 505 are created in the storage unit 108 of the MFP 10. As illustrated in FIG. 6, the folder name of the folder 501 is “Mr. Miyazaki”, the folder name of the folder 502 is “Mr. Tanaka”, the folder name of the folder 503 is “Mr. Suzuki”, the folder name of the folder 504 is “order sheet”, and the folder name of the folder 505 is “development department”.

First, in order to set a distribution destination folder for facsimile data received from a source (transmission source) indicated as “Mr. Miyazaki” in WP 10, the user performs operation for extracting a folder under an extraction condition that “Mr. Miyazaki” is included in the folder name ((1) in FIG. 6).

Then, the MFP 10 searches for a folder having the folder name “Mr. Miyazaki” among the folders 501 to 505 created in the storage unit 108 and extracts the folder 501 having the folder name “Mr. Miyazaki” as the corresponding folder ((2) in FIG. 6).

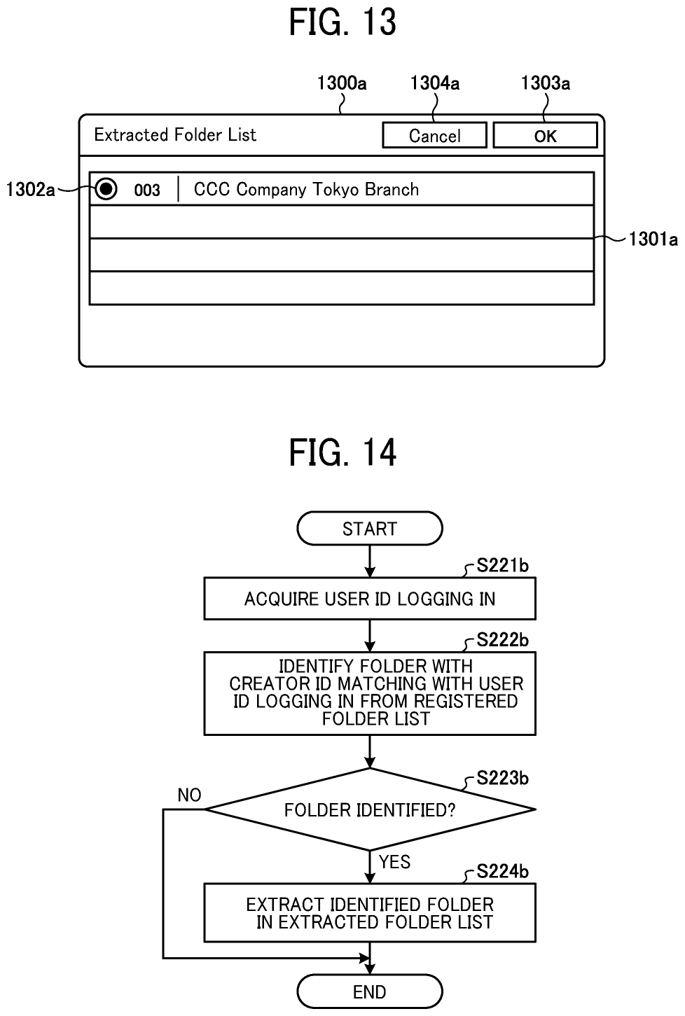

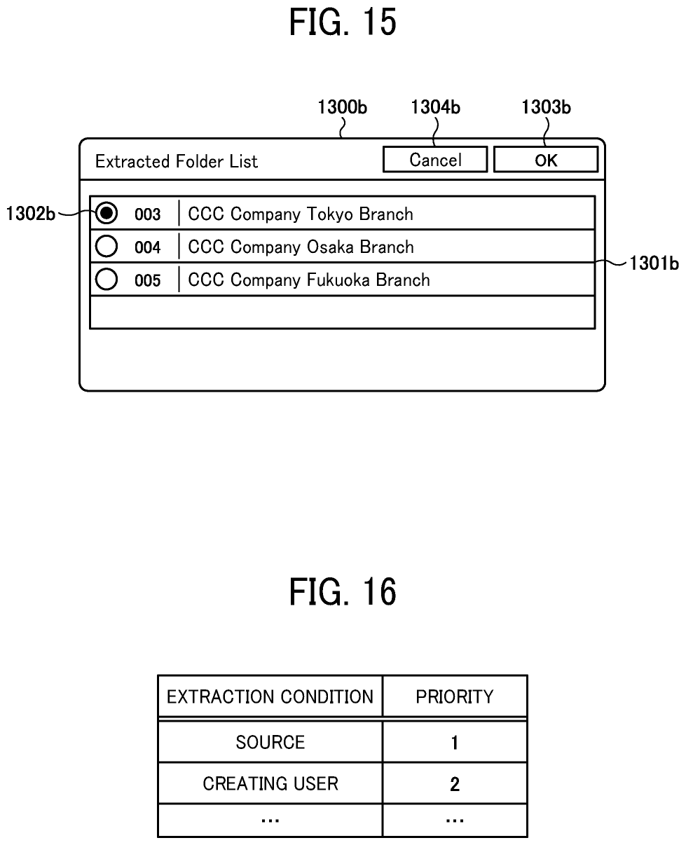

Then, the MFP 10 displays a list of folders (here, the folder 501) extracted as folders satisfying the extraction condition on an extracted folder list screen (see FIGS. 13 and 15 described later) ((3) in FIG. 6).

Thus, it is not necessary to select all the folders in the storage unit 108 as the distribution destination folder of the facsimile data, and it is sufficient to select the folder from the list of the folders extracted by the extraction condition intended by the user. Therefore, it is possible to easily set the folder to be the distribution destination of the facsimile data.

FIG. 7 illustrates the operation of extracting a folder based on an extraction condition that a password is set for the folder and displaying a list of folders that are candidates for a folder to which facsimile data is to be distributed. In addition, as illustrated in FIG. 7, it is assumed that five folders of folders 501 to 505 are created in the storage unit 108 of the MFP 10, similar to FIG. 6.

First, the user performs the operation for extracting a folder under an extraction condition that the password is set for the folder on the MFP 10 ((1) in FIG. 7).

Then, the MFP 10 searches for a folder to which a password is set among the folders 501 to 505 created in the storage unit 108, and extracts a folder 504 whose folder name is “order sheet” and a folder 505 whose folder name is “development department” as corresponding folders ((2) in FIG. 7).

Then, the MFP 10 displays a list of folders (here, the folders 504 and 505) extracted as folders satisfying the extraction condition on the extracted folder list screen (see FIGS. 13 and 15 described below) ((3) in FIG. 7).

Thus, it is not necessary to select all the folders in the storage unit 108 as the distribution destination folder of the facsimile data, and it is sufficient to select the folder from the list of the folders extracted by the extraction condition intended by the user. Therefore, it is possible to easily set the distribution destination folder of the facsimile data.

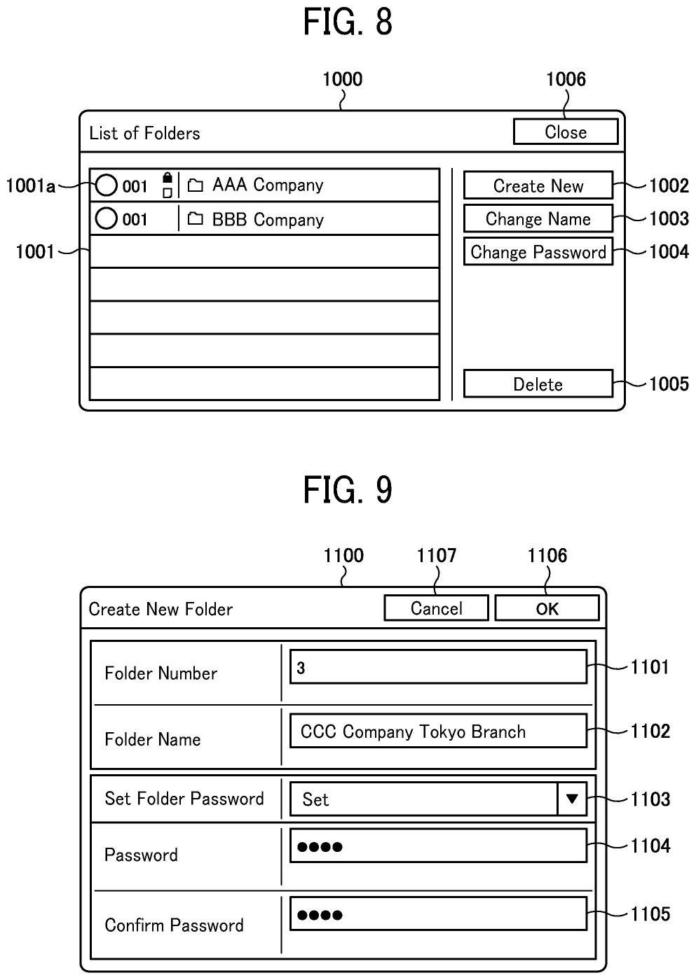

FIG. 8 is a diagram illustrating an example of a folder list screen. FIG. 9 is a diagram illustrating an example of a folder creation screen. Referring to FIGS. 8 and 9, operation of newly creating a folder in the MFP 10 according to the present embodiment is described.

A folder list screen 1000 illustrated in FIG. 8 is a screen for displaying a list of folders already created in the storage unit 108 in the MFP 10. The folder list screen 1000 is displayed on the display unit 106. As illustrated in FIG. 8, the folder list screen 1000 includes a folder list display area 1001, a create button 1002, a change name button 1003, a change password button 1004, a delete button 1005, and a close button 1006.

The folder list display area 1001 is a display area for displaying the list of folders already created in the storage unit 108. A radio button 1001a is arranged in each folder displayed in the folder list display area 1001, and by selecting the radio button 1001a, the folder corresponding to the radio button 1001a can be selected.

The create button 1002 is a button for creating a new folder. The change name button 1003 is a button for changing the folder name of the selected folder. The change password button 1004 is a button for changing the password set for the selected folder.

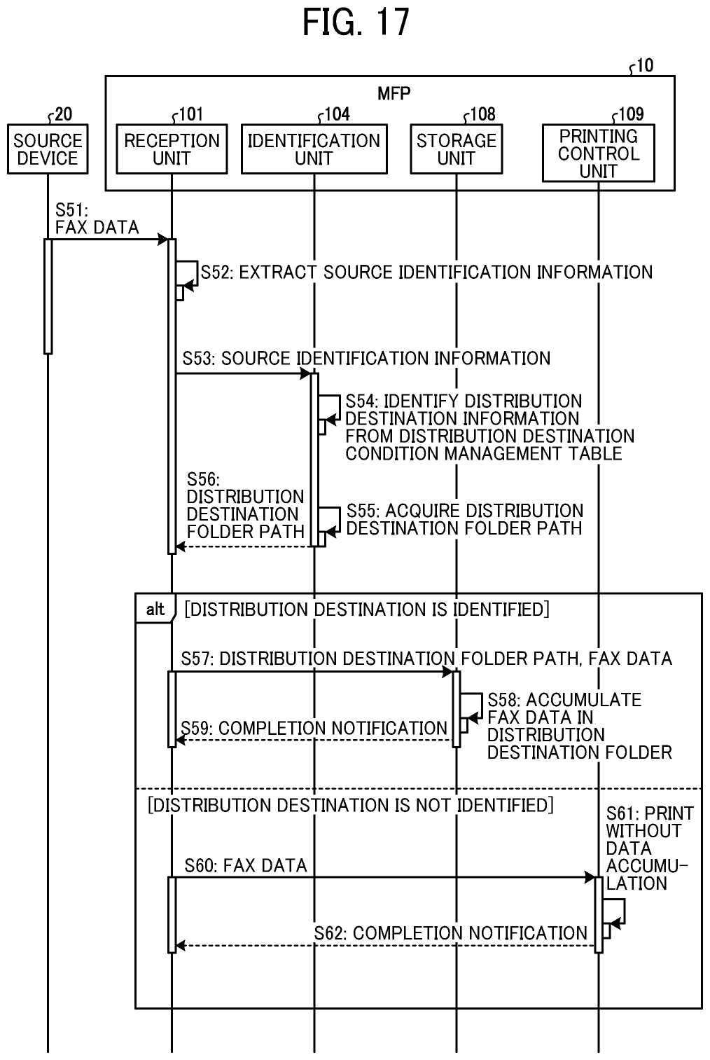

The delete button 1005 is a button for deleting the selected folder. For example, if a folder (distribution destination folder) set as a distribution destination of facsimile data from a specific transmission source among folders displayed in the folder list display area 1001 is deleted by an erroneous operation of the delete button 1005 or the like, the distribution destination of facsimile data from the transmission source disappears. Details of the operation in this case is described below with reference to FIG. 17.

The close button 1006 is a button for closing the folder list screen 1000.

When the user presses the create button 1002 to create a new folder, display control unit 105 of the MFP 10 causes the display unit 106 to display a new folder creation screen 1100 illustrated in FIG. 9. The new folder creation screen 1100 illustrated in FIG. 9 is a screen for setting various types of attribute information for a folder to be newly created. As illustrated in FIG. 9, the new folder creation screen 1100 includes a folder number input field 1101, a folder name input field 1102, a folder password setting field 1103, a password input field 1104, a confirmation password input field 1105, an OK button 1106, and a cancel button 1107.

The folder number input field 1101 is a field for inputting a number for identifying the folder to be newly created. The folder name input field 1102 is a field for inputting a folder name of the folder to be newly created. The folder password setting field 1103 is a combo box for selecting whether a password is necessary for the folder to be newly created. The password input field 1104 is a field for inputting a password to be set in the folder to be newly created when “set” is selected in the folder password setting field 1103. The confirmation password input field 1105 is a field for inputting the password again to confirm the password input to the password input field 1104.

The OK button 1106 is a button for creating a new folder based on attribute information input to the folder number input field 1101, the folder name input field 1102, the folder password setting field 1103, the password input field 1104, and the confirmation password input field 1105. The cancel button 1107 is a button for canceling creation of the new folder.

The user inputs various information to the folder number input field 1101, the folder name input field 1102, the folder password setting field 1103, the password input field 1104, and the confirmation password input field 1105 and presses the OK button 1106. Then, the setting unit 102 of the MFP 10 newly creates a folder based on the input attribute information in the storage unit 108. As information for managing the created folder, the setting unit 102 registers a new record in the folder management table illustrated in FIG. 4 including the folder name input to the folder name input field 1102, the folder path defined by the number input to the folder number input field 1101, the password input to the password input field 1104 (confirmation password input field 1105), the ID of the logged-in user (creator ID), and the date and time of creation of the new folder in association with each other. The setting unit 102 registers “not set” as the distribution condition setting of the registered record.

By the above-described operation, a new folder is created, and attribute information of the folder is registered and stored in the folder management table illustrated in FIG. 4.

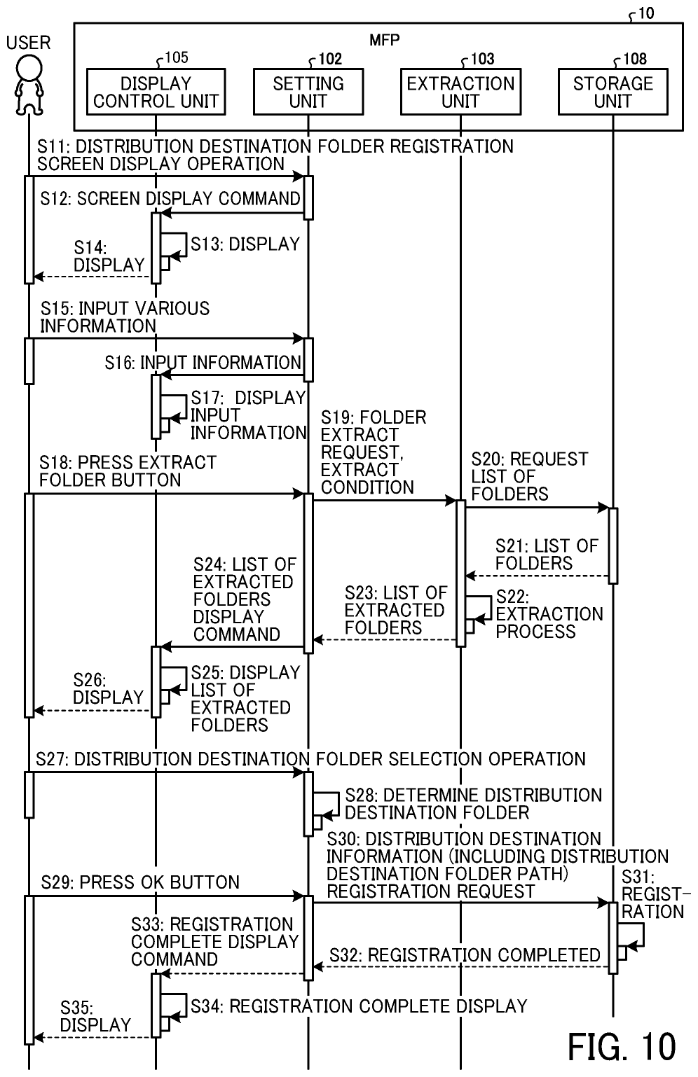

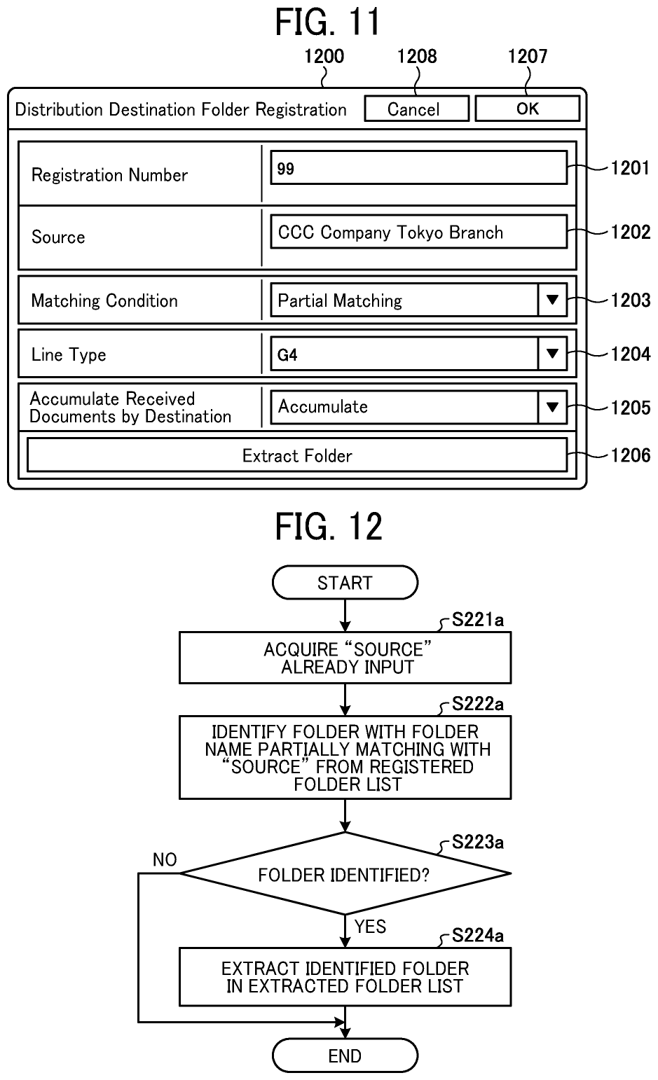

FIG. 10 is a sequence diagram illustrating an example of a distribution destination folder setting process of the MFP according to embodiments of the present disclosure. FIG. 11 is a diagram illustrating an example of the distribution destination folder registration screen. FIG. 12 is a flowchart illustrating an example of a folder extraction process for extracting a folder satisfying a predetermined condition in the distribution destination folder setting process. FIG. 13 is a diagram illustrating an example of the extracted folder list screen. FIG. 14 is a flowchart illustrating another example of the folder extraction process for extracting a folder satisfying a predetermined condition in the distribution destination folder setting process. FIG. 15 is a diagram illustrating another example of the extracted folder list screen. FIG. 16 is a diagram illustrating an example of a priority display setting table. The destination folder setting process executed by the MFP 10 according to the present embodiment is described with reference to FIGS. 10 to 16.

In step S11, a user performs an operation for displaying the distribution destination folder registration screen 1200 illustrated in FIG. 11 through the input unit 107.

In step S12, the setting unit 102 of the MFP 10 sends a command to display the distribution destination folder registration screen 1200 to the display control unit 105. In steps S13 and S14, the display control unit 105 causes the display unit 106 to display the distribution destination folder registration screen 1200 on the display unit in response to the command.

The distribution destination folder registration screen 1200 illustrated in FIG. 11 is a screen for registering the distribution destination folder in which facsimile data is to be distributed and accumulated from a source (transmission source) from which the facsimile data is received. As illustrated in FIG. 11, the distribution destination folder registration screen 1200 includes a registration number input field 1201, a source input field 1202, a matching condition input field 1203, a line type setting field 1204, a storage setting field 1205, a folder extraction button 1206, an OK button 1207, and a cancel button 1208.

The registration number input field 1201 is a field for inputting a number (ID) for uniquely identifying a record in order to register the record as a distribution destination information record in the distribution destination condition management table illustrated in FIG. 5. The source input field 1202 is a field for inputting information (name or the like) indicating a source (transmission source). The matching condition input field 1203 is a combo box for selecting whether to extract a folder having a folder name partially matching the information or to extract a folder having the folder name completely matching the information when extracting a folder by searching for the folder name based on the information input to the source input field 1202.

The line type setting field 1204 is a combo box for selecting the type of a line used for facsimile communication with the source (transmission source) indicated by information input by the source input field 1202. The storage setting field 1205 is a combo box for selecting whether to store facsimile data received from a source (transmission source) indicated by information input by the source input field 1202.

The folder extraction button 1206 is a button for extracting folders satisfying the predetermined extraction condition from the folders created in the storage unit 108 and displaying a list thereof. Here, it is assumed that a folder is extracted based on a matching condition that information (name or the like) input to the folder name by the source input field 1202 matches the matching condition (partial match or complete match) input by the matching condition input field 1203.

The OK button 1207 is a button for registering information input to the registration number input field 1201, the source input field 1202, the matching condition input field 1203, the line type setting field 1204, the storage setting field 1205, and a path of a folder when the folder selected from folders extracted by pressing the folder extraction button 1206 (folders displayed in a list on an extracted folder list screen 1300a illustrated in FIG. 13 or a folder displayed in a list on an extracted folder list screen 1300b illustrated in FIG. 15, which is described below) is set as a distribution destination folder, as the distribution destination information in the distribution destination condition management table illustrated in FIG. 5.

The cancel button 1208 is a button for canceling the process of registering the distribution destination folder.

In the example illustrated in FIG. 11, “99” is input to the registration number input field 1201, “CCC Company Tokyo Branch” is input to the source input field 1202, “partial matching” is input to the matching condition input field 1203, “G4” is input to the line type setting field 1204, and “accumulate” is input to the storage setting field 1205.

Returning to FIG. 10, the description is continued.

In step S15, the user inputs various information to the registration number input field 1201, the source input field 1202, the matching condition input field 1203, the line type setting field 1204, and the storage setting field 1205 on the distribution destination folder registration screen 1200 displayed on the display unit 106 through the input unit 107.

In step S16, the setting unit 102 transmits the information input on the distribution destination folder registration screen 1200 to the display control unit 105. In step S17, the display control unit 105 reflects the information input on the distribution destination folder registration screen 1200 on the display.

In step S18, the user presses the folder extraction button 1206 after inputting various information in the distribution destination folder registration screen 1200 through the input unit 107. In step S19, the setting unit 102 sends the predetermined extraction condition and a folder extraction request for requesting extraction of a folder satisfying the extraction condition to the extraction unit 103. Here, the extraction condition is that information (name or the like) input to the folder name in the source input field 1202 matches the matching condition (partial matching or complete matching) input in the matching condition input field 1203.

In response to receiving the extraction condition and the folder extraction request from the setting unit 102, the extraction unit 103 of the MFP 10 requests from the storage unit 108, a list of all folders created (registered) in the storage unit 108 in step S20. In step S21, the extraction unit 103 receives the list of all folders registered in the folder management table illustrated in FIG. 4.

In step S22, the extraction unit 103 executes the folder extraction process for extracting from all folders, a folder satisfying the extraction condition received from the setting unit 102. A specific folder extraction process is described with reference to FIG. 12.

In step S221a, the extraction unit 103 acquires information (name or the like) indicating the source (transmission source) input to the source input field 1202 of the distribution destination folder registration screen 1200, and the matching condition input in the matching condition input field 1203 (here, it is assumed that partial matching is input). Then, the process proceeds to step S222a.

In step S222a, the extraction unit 103 identifies all folders in which the folder names of the folders included in the folder list already created (registered) in the storage unit 108 partially matching the information indicating the source (transmission source) input to the source input field 1202. Then, the process proceeds to step S223a.

When a partially matching folder is identified by the extraction unit 103 (Yes in step S223a), the process proceeds to step S224a, and when not (No in step S223a), the folder extraction process ends.

In step S224a, the extraction unit 103 extracts a group of the identified folders as an extracted folder list. Then, the folder extraction process ends.

In FIG. 12, the folder extraction process is described under the folder extraction condition that the information (name or the like) input to the folder name by the source input field 1202 matches the matching condition (partial match or complete match) input to the matching condition input field 1203. However, the present disclosure is not limited thereto. For example, folder extraction process under the condition that the user 1D of the user who has logged in to the MFP 10 matches the creator ID of the folder (that is, the condition that a folder created by the user who has logged in is searched for) is described with reference to FIG. 14.

In step S221b, the extraction unit 103 acquires the user ID of the user who has logged in to the MFP 10. Then, the process proceeds to step S222b.

In step S222b, the extraction unit 103 identifies all folders in which the creator IDs of the folders included in the folder list already created (registered) in the storage unit 108 match the user IDs acquired in step S221b. Then, the process proceeds to step S223b.

When a matching folder is identified by the extraction unit 103 (Yes in step S223b), the process proceeds to step S224b. When a matching folder is not identified (No in step S223b), the folder extraction process ends.

In step S224b, the extraction unit 103 extracts a group of the identified folders as an extracted folder list. Then, the folder extraction process ends.

In FIGS. 12 and 14, the operation of extracting a folder under two kinds of extraction conditions as the predetermined extraction conditions has been described, but the present disclosure is not limited thereto. For example, as another extraction condition, only a folder in which a password is set may be extracted, a folder which is not yet set as a distribution destination folder may be extracted, or a folder in which facsimile data or other data is not yet accumulated may be extracted. Furthermore, it is also possible to perform extraction by combining these extraction conditions.

Referring again to FIG. 10, further description is given below.

In step S23, the extraction unit 103 sends a list of extracted folders (extracted folder list) to the setting unit 102 as a response to the above-described folder extraction request.

In step S24, the setting unit 102 sends a command to display the extracted folder list received from the extraction unit 103 to the display control unit 105. In response to the display command, the display control unit 105 causes the display unit 106 to display the extracted folder list screen for displaying the extracted folder list in steps S25 and S26.

FIG. 13 illustrates the extracted folder list screen 1300a for displaying an extracted folder list in a case where a folder is extracted under an extraction condition that information (name or the like) input to the folder name in the source input field 1202 satisfies the matching condition (partial match or complete match) input in the matching condition input field 1203. As illustrated in FIG. 13, the extracted folder list screen 1300a includes an extracted folder list display area 1301a, an OK button 1303a, and a cancel button 1304a.

The extracted folder list display area 1301a is an area for displaying the extracted folder list extracted by the extraction unit 103. In the extracted folder list display area 1301a illustrated in FIG. 13, one folder whose folder name is “CCC Company, Tokyo Branch” is displayed as a folder extracted under the extraction condition when the folder name partially matches “CCC Company, Tokyo Branch” input in the source input field 1202 of the distribution destination folder registration screen 1200. A radio button 1302a is arranged corresponding to each folder displayed in the folder list display area 1301a, and by selecting the radio button 1302a, the folder corresponding to the radio button 1302a can be selected.

The OK button 1303a is a button for confirming a selected folder as a distribution destination folder in the extraction folder list displayed in the extracted folder list display area 1301a. The cancel button 1304a is a button for canceling the operation of selecting the distribution destination folder.

FIG. 15 illustrates an extracted folder list screen 1300b that displays an extracted folder list in a case where a folder is extracted under an extraction condition that the user ID of a user who logged in to the MFP 10 matches the creator ID of the folder. As illustrated in FIG. 15, the extracted folder list screen 1300b includes an extracted folder list display area 1301b, an OK button 1303b, and a cancel button 1304b.

The extracted folder list display area 1301b is an area for displaying the extracted folder list extracted by the extraction unit 103. That is, in the extracted folder list display area 1301b, three folders whose folder names are “CCC Company, Tokyo branch”, “CCC Company, Osaka branch”, and “CCC Company, Fukuoka branch” are displayed as folders in which the creator ID of a folder included in the folder list already created (registered) in the storage unit 108 matches the user ID (here, “User03”) of the user logging in to the MTP 10. A radio button 1302b is arranged corresponding to each folder displayed in the extracted folder list display area 1301b, and by selecting the radio button 1302b, the folder corresponding to the radio button 1302b can be selected.

The OK button 1303b is a button for confirming a selected folder as a distribution destination folder in the extraction folder list displayed in the extracted folder list display area 1301b. The cancel button 1304b is a button for canceling the operation of selecting the distribution destination folder.

As described above, on the extracted folder list screen (for example, the extracted folder list screen 1300a or 1300b), the folders extracted under the predetermined extraction condition are displayed. The user can easily select and set a folder to which the facsimile data is to be distributed.

In the extracted folder list screens 1300a and 1300b described above, only folders extracted under the predetermined extraction conditions are displayed in the list, but the present disclosure is not limited thereto. For example, among the folders acquired by the extraction unit 103 in steps S20 and S21, the folders extracted in step S22 may be preferentially displayed at a higher level, and the remaining folders may be displayed at a lower level. The folder to which the facsimile data is distributed can be easily set also in this case.

Referring again to FIG. 10, further description is given below.

In step S27, the user selects a folder to be set as the distribution destination folder from the extracted folder list screen (for example, the extracted folder list screen 1300a illustrated in FIG. 13, the extracted folder list screen 1300b illustrated in FIG. 15, or the like) through the input unit 107, and presses the OK button (OK button 1303a, 1303b, or the like). In step S28, the setting unit 102 determines (sets) the selected folder as the distribution destination folder to which facsimile data from the source (transmission source) set on the distribution destination folder registration screen 1200 is to be distributed. Then, the display control unit 105 hides the extracted folder list screen and displays the distribution destination folder registration screen 1200.

In step S29, the user presses the OK button 1207 on the distribution destination folder registration screen 1200 through the input unit 107. In step S30, the setting unit 102 requests the storage unit 108 to register information input to the registration number input field 1201, the source input field 1202, the matching condition input field 1203, the line type setting field 1204, and the storage setting field 1205 of the distribution destination folder registration screen 1200 and information including the path of the distribution destination folder to which the determined (set) facsimile data is to be distributed as the distribution destination information.

In step S31, the storage unit 108 registers the distribution destination information received from the setting unit 102 as a new record in the distribution destination condition management table illustrated in FIG. 5. As illustrated in FIG. 5, the storage unit 108 registers in association with each other, “99” input to the registration number input field 1201 of the distribution destination folder registration screen 1200 as an ID, “CCC Company, Tokyo branch” input to the source input field 1202 as source information, “partial match” input to the matching condition input field 1203 as a matching condition, “G4” input to the line type setting field 1204 as a line type, “accumulate” input to the storage setting field 1205 as the data accumulation, and a determined (set) destination folder path as the distribution folder. When the distribution destination information is registered in the distribution destination condition management table of the storage unit 108, the setting unit 102 receives information indicating that the registration is completed in step S32.

In step S33, the setting unit 102 sends a display command indicating the completion of the registration to the display control unit 105. In steps S34 and S35, the display control unit 105 causes the display unit 106 to display the completion of the registration of the distribution destination information in response to the reception of the display command.

The distribution destination folder setting process is performed as described above in steps S11 to S35.

Although FIG. 10 illustrates an operation of selecting a folder as the distribution destination folder from a list of folders extracted based on the predetermined extraction condition, the present disclosure is not limited thereto, and a folder may be set as a distribution destination folder directly from the registered folders.

In addition, extraction may be performed by combining the extraction conditions described above. In this case, as a method of combining the extraction conditions, for example, folders satisfying both a first extraction condition and a second extraction condition may be extracted and displayed in a list, or a list of folders extracted under the first extraction condition and a list of folders extracted under the second extraction condition may be displayed side by side. For example, in the latter case, a priority display setting table illustrated in FIG. 16 may be set in advance in the storage unit 108, and a list of extracted folders may be displayed on the extracted folder list screen (refer to FIG. 13 or 15) in accordance with the priority order set in the table. In the example illustrated in FIG. 16, the priority order of the extraction condition “source” (an extraction condition that information (name or the like) input to folder name in the source input field 1202 matches the search condition (partial match or complete match) input by the matching condition input field 1203) input to the matching condition input field 1203 is “1”, and the priority order of the extraction condition “creating user” (the extraction condition that the user ID of the user logging in the MFP 10 matches the creator ID of the folder) is “2”. Therefore, for example, the display control unit 105 may display the folder extracted under the extraction condition “source” at a higher level and display the folder extracted under the extraction condition “creating user” at a lower level on the extracted folder list screen. In the case where folders extracted under a plurality of extraction conditions overlap, the folders may be displayed, for example, at the top of the extracted folder list screen.

The extraction condition to be applied may be set in advance by the setting unit 102. In this case, the extraction condition to be applied may be set by the setting unit 102 for each logged-in user.

FIG. 17 is a sequence diagram illustrating an example of a facsimile reception process of the MFP according to the present embodiment. With reference to FIG. 17, the facsimile reception process executed by the MFP 10 according to the present embodiment is described.

In step S51, the reception unit 101 of the MFP 10 receives the facsimile data transmitted from the source device 20 of the source (transmission source).

In step S52, the reception unit 101 extracts transmission source identification information (for example, a facsimile number of the source or a device name of the source device) for identifying the source (transmission source) from the received facsimile data. In step S53, the reception unit 101 transmits the extracted transmission source identification information to the identification unit 104.

In step S54, the identification unit 104 identifies the distribution destination information (record) corresponding to the received transmission source identification information by referring to the distribution destination condition management table stored in the storage unit 108. For example, the identification unit 104 identifies the distribution destination information by comparing the source information of the distribution destination information in the distribution destination condition management table with the transmission source identification information. In step S55, the identification unit 104 acquires the distribution destination folder path from the identified distribution destination information, and in step S56, transmits the distribution destination folder path to the reception unit 101.

In this case, when the identification unit 104 identifies the distribution destination information and acquires the distribution destination folder path (that is, when the distribution destination folder is identified by the identification unit 104), the process proceeds to step S57. On the other hand, when the destination information is not identified by the identification unit 104 (that is, when the identification unit 104 did not identify the distribution destination folder), the process proceeds to step S60.

When the identification unit 104 identifies the distribution destination folder of the facsimile data, the reception unit 101 transmits the received facsimile data and the distribution destination folder path received from the identification unit 104 to the storage unit 108 in step S57. In step S58, the storage unit 108 accumulates facsimile data in the storage area indicated by the distribution destination folder path (that is, the distribution destination folder), and in step S59, sends a notification to the reception unit 101 that the accumulation is completed.

When the distribution destination folder of the facsimile data is not identified by the identification unit 104, the reception unit 101 transmits the received facsimile data to the printing control unit 109 in step S60.

In step S61, the printing control unit 109 prints out the facsimile data received from the reception unit 101. In this case, since there is no distribution destination folder of the facsimile data received by the reception unit 101, the facsimile data is not accumulated in the storage unit 108. Accordingly, shortage of the storage capacity of the storage unit 108 can be prevented. In step S62, the printing control unit 109 sends information indicating that printing has been completed to the reception unit 101. In this case, the email transmission unit 110 may transmit an email to a predetermined email address (for example, an email address of an administrator or the like) through the network I/F 804b to notify that the distribution destination folder is not identified by the identification unit 104 and the facsimile output printed by the printing control unit 109 is received (or printed) by the reception unit 101. In addition to transmitting the fact that the facsimile data has been received by the reception unit 101 (or has been printed), the email transmission unit 110 may attach the facsimile data to the email. Accordingly, a person (administrator or the like) who is a transmission destination of the email can recognize that the facsimile data having no distribution destination folder has been received and printed out by the printing control unit 109. In addition, in a case where the facsimile data in which the distribution destination folder is not identified is printed and output by the printing control unit 109, the facsimile data may not be accumulated in the storage unit 108 but may be accumulated in, for example, an administrator folder or a shared folder.

The facsimile reception process is performed as described above in steps S51 to S62.

As described above, in the MFP 10 according to the present embodiment, when the reception unit 101 receives facsimile data and the identification unit 104 cannot identify the distribution destination folder of the facsimile data, the printing control unit 109 prints out the facsimile data. Thus, contents of facsimile data whose location may become unknown when distribution destination folder is not identified can be quickly confirmed.

In the MFP 10 according to the present embodiment, the email transmission unit 110 transmits to a predetermined email address (for example, an email address of an administrator or the like) through the network I/F 804b, an email indicating that the reception unit 101 has received facsimile data whose distribution destination folder has not been identified by the identification unit 104 and printed by the printing control unit 109. Accordingly, a person (administrator or the like) who is a transmission destination of the email can recognize that the facsimile data having no distribution destination folder has been received and printed out by the printing control unit 109.

Each of the functions of the above-described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), a system on a chip (SOC), a graphics processing unit (GPU), and conventional circuit components arranged to perform the recited functions.

In the above-described embodiment, when at least one of the functional units in the MFP 10 is implemented by executing a program, the program is provided by being incorporated in a ROM or the like in advance. The program executed in the MFP 10 according to the above-described embodiment may be provided by being recorded in a computer-readable recording medium such as a compact disc read only memory (CD-ROM), a flexible disk (FD), a compact disk-recordable (CD-R), a digital versatile disk (DVD), or a secure digital (SD) card as a file in an installable format or an executable format. The program executed in the MFP 10 according to the above-described embodiment may be stored in a computer connected to a network such as the internet and provided by being downloaded through the network. The program executed in the MFP 10 according to the above-described embodiment may be provided or distributed through a network such as the internet. The program executed in the MFP 10 according to the above-described embodiment has a module configuration including at least one of the above-described functional units. As actual hardware, the CPU reads the program from the above-described storage device and executes the program, whereby the above-described functional units are loaded onto the main storage device and generated.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An information processing apparatus comprising:
circuitry configured to:
receive facsimile data;
identify a distribution destination folder to which the facsimile data is to be accumulated, from among one or more folders in one or more memories; and
when the distribution destination folder is not identified, control a printer to print out an image based on the facsimile data.

2. The information processing apparatus of claim 1, wherein
when the distribution destination folder to which the facsimile data is to be accumulated is not identified, the circuitry is further configured to transmit to a predetermined email address, an email indicating that the facsimile data has been printed out from the printer.

3. The information processing apparatus of claim 2, wherein
the circuitry is further configured to attach the facsimile data to the email to be transmitted to the predetermined email address.

4. The information processing apparatus of claim 1, wherein
when the distribution destination folder is identified, the circuitry is further configured to accumulate the facsimile data in the distribution destination folder of the one or more folders.

5. The information processing apparatus of claim 1, wherein
when the distribution destination folder is not identified, the circuitry is configured not to accumulate the facsimile data in any one of the one or more folders.

6. The information processing apparatus of claim 1, wherein
the circuitry is further configured to set a particular one of the one or more folders as the distribution destination folder for each transmission source of the facsimile data.

7. An information processing method comprising:
receiving facsimile data;
identifying a distribution destination folder to which the received facsimile data is to be accumulated, from among one or more folders in one or more memories; and
controlling a printer to print out an image based on the facsimile data when the distribution destination folder is not identified.

8. A non-transitory recording medium storing a plurality of instructions which, when executed by one or more processors on an information processing apparatus, causes the processors to perform an information processing method, comprising:
receiving facsimile data;
identifying a distribution destination folder to which the received facsimile data is to be accumulated, from among one or more folders in one or more memories; and
controlling a printer to print out an image based on the facsimile data when the distribution destination folder is not identified.
